(19) United States
(12) Patent Application Publication
(10) Pub. No.: US 2023/0016469 A1
(43) Pub. Date: Jan. 19, 2023

(54) A FERTILIZER GRANULE OF POLYHALITE AND POTASSIUM SULPHATE AND A COMPACTION PROCESS FOR THE PRODUCTION THEREOF

(71) Applicant: ICL EUROPE COOPERATIEF U.A., Amsterdam (NL)

(72) Inventors: Khalil ABU-RABEAH, Beer Sheva (IL); Ruben SOCOLOVSKY, Beer Sheva (IL); Marina DAKOV, Arad (IL); Yacov LEVY, Dimona (IL); Natalia GEINIK, Arad (IL); Moshe GOLDFARB, Beer Sheva (IL)

(21) Appl. No.: 17/785,929

(22) PCT Filed: Dec. 28, 2020
(86) PCT No.: PCT/IL2020/051339

§ 371 Date: Jun. 16, 2022

Related U.S. Application Data
(60) Provisional application No. 62/966,099, filed on Jan. 27, 2020.

(51) Int. Cl. C05D 1/00; C05G 5/12; C05G 5/40

(52) U.S. Cl. CPC C05D 1/005; C05G 5/12; C05G 5/40

(57) ABSTRACT

According to some demonstrative embodiments, there is provided herein a fertilizer granule comprising Polyhalite and potassium sulphate, wherein said Polyhalite is present in a concentration of 30-70% w/w and said Potassium Sulphate is present in a concentration of 70-30% w/w, wherein the strength of granule immediately after production 1.3 Kg granule.

### FIELD OF THE INVENTION

The present invention relates to the field of composite fertilizers, specifically to production of compacted Polyhalite fertilizers.

### BACKGROUND OF THE INVENTION

To grow properly, plants need nutrients (nitrogen, potassium, calcium, zinc, magnesium, iron, manganese, etc.) which normally can be found in the soil. Sometimes fertilizers are needed to achieve a desired plant growth as these can enhance the growth of plants.

This growth of plants is met in two ways, the traditional one being additives that provide nutrients. The second mode by which some fertilizers act is to enhance the effectiveness of the soil by modifying its water retention and aeration. Fertilizers typically provide, in varying proportions, three main macronutrients:

Nitrogen (N): leaf growth;

Phosphorus (P): Development of roots, flowers, seeds, fruit;

Potassium (K): Strong stem growth, movement of water in plants, promotion of flowering and fruiting;

three secondary macronutrients: calcium (Ca), magnesium (Mg), and Sulphur (S); micronutrients: copper (Cu), iron (Fe), manganese (Mn), molybdenum (Mo), zinc (Zn), boron (B), and of occasional significance there are silicon (Si), cobalt (Co), and vanadium (V) plus rare mineral catalysts. The most reliable and effective way to make the availability of nutrients coincide with plant requirements is by controlling their release into the soil solution, using slow release or controlled release fertilizers.

Polyhalite is an evaporite mineral, a hydrated sulfate of potassium, calcium and magnesium with formula: K₂Ca2Mg(SO₄)₄ 2H₂O. Polyhalite is used as a fertilizer since it contains four important nutrients and is low in chloride:

48% SO₃ as sulfate

14% K₂O

6% MgO

17% CaO

Potassium sulfate (in British English potassium sulphate (SOP), also called sulphate of potash, arcanite, or archaically known as potash of sulfur) is the inorganic compound with formula K₂SO₄. It is a white water-soluble solid providing both potassium and a source of sulfur to a plant when used as a fertilizer.

### SUMMARY OF THE INVENTION

According to some demonstrative embodiments, there is provided herein a fertilizer granule comprising Polyhalite and potassium sulphate, wherein the Polyhalite may be present in a concentration of 30-70% w/w and the Potassium Sulphate may be present in a concentration of 70-30% w/w, wherein the strength of granule immediately after production may be at least 1.3 Kg granule.

According to some embodiments, the Polyhalite may be present in a concentration of 40-60% w/w and the Potassium Sulphate may be present in a concentration of 60-40% According to some embodiments, the granule may further comprise a binder in a concentration of between 0.1-5% w/w.

According to some embodiments, the binder may be selected from the group including organic or inorganic binders, such as, starch, bentonite, sodium silicate, lignosulfonates, molasses, hydrated lime, bitumen, Portland cement, clay, acids (nitric, hydrochloric, phosphoric, sulphuric), cellulose gum, sucrose, water, water glass, cements, or combinations thereof.

According to some embodiments, the binder may preferably be selected from the group including: Starch, activated starch, whether alone or in combination with potassium silicate; meta kaolin; potassium silicate; sodium silicate or a combination thereof.

According to some embodiments, the binder may preferably be activated starch.

According to some embodiments, there is provided herein a compaction process comprising the following steps: mixing Polyhalite with Potassium sulphate to provide a mixture; adding organic or inorganic binder in a concentration between 1-5% w/w preferably between 2-4% w/w; adding water between 0.5-2%, preferably 0.5-1%; heating the mixture to a temperature between 80-180° C.; feeding said mixture into a compactor to provide compacted flakes; grinding of said flakes to provide ground flakes; and sieving said ground flakes.

According to some embodiments, the sieving may result in three types of yield: Desired sized flakes—between 2-4 mm thickness, S.G. between 1.9 to 2.4 g/cm³; Oversized (OS) flakes—between 4-20% w/w of the total resulting flakes; and Undersized (US) flakes—between 10 to 80% w/w of the total resulting flakes.

There is provided herein a process for the compaction of Polyhalite with a potassium Sulphate. The process comprising: mixing a feed of polyhalite with a feed of said potassium Sulphate salt and binder in a mixer to yield a mixture; compacting in a compactor to yield masses; crushing said masses in a crusher to yield particles; and screening said particles in a screener to yield different particles in three different sizes: oversized particles which undergo a second crushing process and are retuned to said screener for screening, undersized particles which are transferred to said mixer for further mixing, and desired size granular particles which are transferred to a polish screener.

The final product contain: N, K, SO₄, MgO, CaO

### DETAILED DESCRIPTION OF THE INVENTION

According to some demonstrative embodiments, there is provided herein a fertilizer granule comprising 30-70% w/w Polyhalite and 70-30% w/w of

Potassium sulphate and optionally a binder, preferably, 40-60% w/w Polyhalite and 60-40% w/w of Potassium sulphate.

According to some embodiments, it has been surprisingly found that although both polyhalite and SOP are both sulphate salts, the resulting granule exhibits superior strength properties.

According to some demonstrative embodiments, adding SOP to a polyhalite granule elevates the concentrations of Potassium and sulphate in the granule, while maintaining the granule as chloride free.

According to some demonstrative embodiments, a number of cash crops, such as vegetables, fruits, nuts and field crops, are known for their sensitivity to chloride. Chloride toxicity is expressed in the affected plants as leaf scorching. When the chloride concentration in the soil solution increases, plants take up chloride on the account of essential anionic nutrients, and this may result in reduced crop yield and quality.

Traditional preparation processes of chloride-free potash fertilizers (KNO₃, K₂CO₃ and K₂SO₄) have certain limitations, such as complicated operation and existing potential pollution.

According to some demonstrative embodiments, the combination of SOP and polyhalite in a single granule possess numerous surprising advantages.

According to some embodiments, the granule of the present invention comprises two different sources for providing the plant with Potassium and Sulphate. According to some embodiments, the first source may be polyhalite, and the second source may be SOP. According to some embodiments, SOP and Polyhalite comprise different dissolution rates, and according to some embodiments enable a plant exposed to the granule of the present invention to absorb vital nutrients such as Potassium and Sulphate in quick rate and in a controlled, e.g., slower, rate.

According to some embodiments, the dissolution quantity of SOP is 120 g L⁻¹ at 25° C.

According to some embodiments, the dissolution of SOP can further be enhanced by adding one or more additives which ameliorate the diffusion coefficient (D) and the diffusion layer thickness (h), such as sodium tripolyphosphate (STPP) and/or urea phosphate (UP).

Polyhalite on the other hand, upon contact with water precipitates as gypsum and syngenite and magnesium sulphate.

According to some embodiments, the granule of the present invention may further include one or more additional fertilizers, for example, selected from the group including any material of natural or synthetic origin that is applied to soils or to plant tissues to supply one or more plant nutrients essential to the growth of plants, including, for example, Single nutrient (“straight”) fertilizers such as Ammonium nitrate, Urea, calcium ammonium nitrate, superphosphate, e.g., “Single superphosphate” (SSP), phosphogypsum, Triple superphosphate (TSP) or a mixture thereof; Multinutrient fertilizers such as Binary (NP, NK, PK) fertilizers, e.g., monoammonium phosphate (MAP) and/or diammonium phosphate (DAP), NPK fertilizers which are three-component fertilizers providing nitrogen, phosphorus, and potassium; fertilizers which include one or more of the main micronutrients sources of iron, manganese, boron, molybdenum, zinc, and copper and the like; Compound fertilizers, e.g., which contain N, P, and K; Organic fertilizers such as peat, animal wastes, plant wastes from agriculture, and sewage sludge; and/or Other elements such as calcium, magnesium, and sulfur.

According to some demonstrative embodiments, the granule of the present invention may also include one or more binders, e.g., selected from the group including any suitable material or compound that may mechanically and/or chemically hold or draw other materials together to form a cohesive whole including, for example, organic or inorganic binders, such as, starch, bentonite, sodium silicate, lignosulfonates, molasses, hydrated lime, bitumen, Portland cement, clay, acids (nitric, hydrochloric, phosphoric, sulphuric), cellulose gum, sucrose, water, water glass, cements, or combinations thereof.

According to some demonstrative embodiments, the binder may preferably be selected from the group including: Starch, most preferably, activated starch, whether alone or in combination with potassium silicate; meta kaolin; potassium silicate; sodium silicate or a combination thereof.

According to some preferable embodiments, the binder is activated starch.

According to some embodiments, the granule of the present invention may comprise a binder in a concentration of between 0.1-5% w/w, preferably 0.5-3% w/w, most preferably 1-2% w/w.

According to some embodiments, the ratio between polyhalite and SOP in the granule may be 1.1:0.9 to 0.9:1.1.

According to some embodiments, there is provided herein a compaction process comprising
mixing a mixture of 30-70% w/w Polyhalite and 70-30% of Potassium sulphate w/w and optionally a binder;
mixing is performed in a blade blender and/or any other suitable device capable of having a rotation speed that creates a swirling motion for a perfect homogenization and a high blending precision, e.g., a Ploughshare® Mixer.
Performing a wet compaction of the mixture.

According to some embodiments, the compaction process may include the addition of a binder in a concentration of 1-5% w/w.

According to some embodiments, the binder may include but not limited: for example, organic or inorganic binders, such as, starch, bentonite, sodium silicate, lignosulfonates, molasses, hydrated lime, bitumen, Portland cement, clay, cellulose gum, sucrose, water, water glass, cements, Fly Ash,

Potassium and Sodium Silicate, MgO, CaO, Alganite, Geo-polymers, oils and waxes and the like, or a combination thereof.

According to some demonstrative embodiments, the compaction process may be a dry compaction process and may include the following steps:
Mixing Polyhalite with Potassium sulphate;
Optionally adding micronutrients;
Adding organic or inorganic binder in a concentration between 1-5% w/w preferably between 2-4% w/w;
Adding water between 0.5-2%, preferably 0.5-1%.

According to some embodiments, the mixture may be heated to a temperature between 80-180° C., preferably 160° C.

Feeding the mixture into a compactor to provide compacted flakes;

Grinding of the flakes;

Sieving of the grinded flakes; and

After sieving there are three types of yield:
1. Desired sized flakes—between 14-33 mm thickness, S.G. between 1.9 to 2.4 g/cm³. According to some embodiments, the desired size of the flakes (also referred to herein as “particles” or “granules”) is between 1-6 mm, most preferably between 2-4 mm.
2. Oversized (OS) flakes—are returned to the grinding stage, e.g., between 4-20% w/w of the total resulting flakes.
3. Undersized (US) flakes—are recycled to the mixture for compaction, e.g., between 10 to 80% w/w of the total resulting flakes.

According to some embodiments, in the dry process, optionally a binder may be added in a concentration of between 0.01-7% w/w, preferably between 1-5% w/w, most preferably between 2-4% w/w.

The final product may be submitted to post-treatment. Oil may be added to the resulting granules, e.g., to improve the rheology of the product and diminish dust formation. Polishing the granules or Coating. The resulting flakes/granules may be glazed and further coated with a suitable coating. For example, the coatings may include biodegradable coatings, sustained release coatings, controlled release coatings, oily coatings, wax coatings.

The dry compaction process may include the following steps:
1. Mixing materials—Polyhalite, potassium sulphate in 200 lit mixer
2. Adding binder
3. Adding water
4. Compacting—Diameter 600 mm, width 145 mm. working force 100-90 KN/cm. roll velocity 6 rpm.
5. Crushing using hammer mill—
6. Screening
7. Drying the granule between 2-4 mm Single strength 1.3 Kg/granules
8. Recycling-80%
9. Analysis. All analyses conducted according to the standard procedure

### Example 1

50% polyhalite+50% potassium sulphate

Abrasion in—12 mesh 58% immediately, 46% after 24 hours

Eco dust 3% immediately, 2.9% after 24 hours

Strength of granule immediately after production 1.3 Kg granule

Strength of granule after 24 hours 1.8 Kg/granule

Strength of granule after 1 month 3 Kg granule

### Example 2

49% polyhalite+49% potassium sulphate+0.7-2% water

Abrasion in—12 mesh 37% immediately, 27% after 24 hours

Eco dust 2.2% immediately, 1.9% after 24 hours

Strength of granule immediately after production 1.8 Kg granule

Strength of granule after 24 hours 2.4 Kg/granule

Strength of granule after 1 month 3.9 Kg granule

### Example 3

48% polyhalite+48% potassium sulphate+2% lignosulphonate+0.7-1% water

Abrasion in—12 mesh 21% immediately, 18% after 24 hours

Eco dust 1.26%, immediately, 1.1% after 24 hours

Strength of granule immediately after production 1.7 Kg granule

Strength of granule after 24 hours 2.3 Kg/granule

Strength of granule after 1 month 4.3 Kg granule

### Example 4

50% polyhalite+41% potassium sulphate+2% starch+7% water Strength of granule immediately after production 2.6 Kg granule

### Example 5

50% polyhalite+41% potassium sulphate+2% metakaoline+7% water Strength of granule immediately after production 1.4 Kg granule.

### Example 6

50% polyhalite+41% potassium sulphate+2% potassium silicate+7% water.

Strength of granule immediately after production 2.6 Kg granule. 50%

### Example 7

polyhalite+41% potassium sulphate+1% starch+1% potassium silicate+7% water

Strength of granule immediately after production 2 Kg granule

1. A fertilizer granule comprising Polyhalite and potassium sulphate, wherein said Polyhalite is present in a concentration of 30-70% w/w and said Potassium Sulphate is present in a concentration of 70-30% w/w, wherein the strength of granule immediately after production 1.3 Kg granule.

2. The granule of claim 1, wherein Polyhalite is present in a concentration of 40-60% w/w and said Potassium Sulphate is present in a concentration of 60-40%

3. The granule of claim 1, further comprising a binder in a concentration of between 1-5% w/w.

4. The granule of claim 3, wherein said binder is selected from the group including organic or inorganic binders, such as, starch, bentonite, sodium silicate, lignosulfonates, molasses, hydrated lime, bitumen, Portland cement, clay, acids (nitric, hydrochloric, phosphoric, sulphuric), cellulose gum, sucrose, water, water glass, cements, or combinations thereof.

5. The granule of claim 4, wherein said binder is selected from the group including: Starch, activated starch, whether alone or in combination with potassium silicate; meta kaolin; potassium silicate; sodium silicate or a combination thereof.

6. The granule of claim 5, the binder is activated starch.

7. The granule of claim 4, wherein said binder is present in a concentration of between 0.1-5% w/w.

8. A compaction process comprising the following steps:
Mixing Polyhalite with Potassium sulphate to provide a mixture;
Adding organic or inorganic binder in a concentration between 1-5% w/w preferably between 2-4% w/w;
Adding water between 0.5-2%, preferably 0.5-1%;
Heating said mixture to a temperature between 80-180° C.;
Feeding said mixture into a compactor to provide compacted flakes;
Grinding of said flakes to provide ground flakes; and
Sieving said ground flakes.

9. The process of claim 8, wherein said sieving results in three types of yield:
Desired sized flakes—between 2-4 mm thickness, S.G. between 1.9 to 2.4 g/cm³.
Oversized (OS) flakes—between 4-20% w/w of the total resulting flakes.
Undersized (US) flakes—between 10 to 80% w/w of the total resulting flakes.
